(19) United States
(12) Patent Application Publication
(10) Pub. No.: US 2006/0193219 A1
(43) Pub. Date: Aug. 31, 2006

(54) Diffraction grating, optical pickup device, and optical disk apparatus

(76) Inventors: Tomoto Kawamura, Tokyo (JP); Katsuhiko Izumi, Kamakura (JP); Kunikazu Ohnishi, Yokosuka (JP); Kenichi Shimada, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/334,453

(22) Filed: Jan. 19, 2006

(30) Foreign Application Priority Data
Feb. 28, 2005 (JP) 2005-052246

(51) Int. Cl. G11B 7/00

(52) U.S. Cl. 369/44.37; 369/44.14; 369/44.41

(57) ABSTRACT

An optical pickup device is provided which reduces variations in amplitude of a tracking error signal in a seek operation due to an installation error of the optical pickup device onto an optical disk apparatus, thereby generating the tracking error signal with high accuracy without any influence from stray lights, and which is high in productivity and low cost. Two sub-light beams are focused on at least one of forward and backward sides in a rotational direction of the disk with respect to a main light beam focused on the disk. When n is an integer number, and t is a distance between guide grooves of the disk, the two sub-light beams focused are spaced apart from each other by a distance of t×(n+0.5) in the radial direction of the optical disk. As splitting means for splitting the light beams into a plurality of beams, a diffraction grating is used which has grid grooves spaced apart at equal intervals, but having different angles at the upper and lower parts of an exiting surface of the light beam.

### FIELD OF THE INVENTION

The present invention relates to tracking technology for an optical pickup device mounted on an optical disk apparatus.

### BACKGROUND OF THE INVENTION

In recent years, optical disk apparatus have been widely used which are capable of recording and reproducing information on a recording medium, such as a CD-R/RW, or a DVD-R/RW. Particularly, there has been recently developed an optical disk apparatus that employs a high-density optical disk, such as a Blue-ray, or a HD-DVD, as compared to a DVD. Such an optical disk apparatus is designed to record information by irradiating the optical disk with a light beam by an optical pickup device incorporated therein, and to read information by detecting a reflected light beam from the disk.

To record and reproduce the information by the optical pickup device in a stable manner, it is necessary to cause the light beam to follow a guide groove formed on the optical disk. The technology for permitting the light beam to follow the groove is called tracking. In the optical pickup device, a control signal for high-accuracy tracking is generated from the reflected light beam from the optical disk. The control signal is hereinafter referred to as a tracking error signal.

Various methods for detecting the tracking error signal are known. For example, a differential push pull method (hereinafter referred to as DPP) is disclosed in a patent document 1 (JP-B No. 4-34212, at page 6 and in FIG. 7). In the DPP method, a light beam is split into three beams, namely, one main light beam and two sub-light beams by a grating. The three beams are focused on the optical disk by an objective lens to form three beam spots thereon such that two spots of the sub-light beams on the disk are respectively spaced apart from the spot of the main beam by ±½ track in a radial direction of the disk. Each of three light beams reflected off the optical disk enters a pair of receiving areas, which are separated into two parts, to produce a corresponding push-pull signal. A difference between the push-pull signal generated from the main beam (hereinafter referred to as MPP), and the sum of the push-pull signals generated from the two sub-light beams (hereinafter referred to as SPP) is calculated to obtain a tracking error signal (hereinafter referred to as TES).

Another patent document 2 (for example, JP-A No. 12700/1993, at page 4 and in FIG. 2) discloses that two spots of the sub-light beams are formed at each of forward and backward parts on the disk with respect to a spot of the main light beam such that the spots of sub-light beams lie on different edges of a track where the main beam spot is located, thereby producing the tracking error signal by the reflected light. With this arrangement, no offset occurs in the tracking error signal at the boundary between a recorded part and a non-recorded part of the optical disk, so that the light beam can follow the track in a stable manner.

A further patent document 3 (for example, JP-A No. 307351/2001, at page 6 and FIG. 1) discloses that two spots of the sub-light beams are formed at forward and backward parts on the disk with respect to a spot of the main light beam such that these sub-beam spots are respectively spaced apart by 1.5 track from a track where the main beam spot is located, thereby producing the tracking error signal by the reflected light. The patent document 3 has the same effect as that of the aforesaid document 2.

A non-patent document 1 (Sharp Technical Journal, No. 90 (at pages 38 and 43 and in FIG. 3) proposes an original phase-shift DPP servo method. In this method, a predetermined phase is added to a sub-light beam using a phase diffraction grating, thereby detecting SPP signal having no amplitude as the push-pull signals from the reflected light beams from the optical disk. This can provide an optical pickup device whose performance does not depend on a distance between guide grooves on the disk, and on an angle of the guide groove.

### SUMMARY OF THE INVENTION

The optical disk apparatus employing the DVD or CD are widely used, whereas low-cost competition is now heating up. For this reason, simplifying assembly steps is a very important factor, in addition to cost reduction of components.

In order to read out data from the rotating optical disk, the optical disk apparatus has a mechanism adapted to read all data from the disk by moving the optical pickup device from the inner track to the outer track of the disk. Such movement of the pickup from the inner to the outer tracks is generally called “seek”. In the DPP as described in the document 1, which is the most common method for generating a tracking error signal, seeks should be done by aligning the objective lens of the optical pickup device in the predetermined radial direction of the disk. This is because when the optical pickup device)seeks the disk apart from the predetermined radial direction of the disk, the angles of appropriate three beams on the inner track of the disk may become different from those on the outer track, leading to variations in amplitude of the tracking error signal. It should be noted that when the optical pickup device seeks the disk, such a seek operation of the pickup apart from the predetermined disk radial direction is called “off center”.

Thus, the optical pickup device needs to be mounted on the optical disk apparatus with very high accuracy, which takes much time to assemble, resulting in low in productivity, which is a factor of increase in cost.

It is supposed that in a pickup device having compatibility between the Blu-ray and the DVD, the optical pickup device should mount thereon two objective lenses for a high-speed operation. However, when two objective lenses are arranged in the rotational direction of the optical disk, at least one lens cannot be aligned in the predetermined radial direction of the disk, thus failing to seek. Further, the angles of appropriate three beams on the inner track of the disk may become different from those on the outer track, leading to large variations in amplitude of the tracking error signal, whereby the light beam cannot disadvantageously follow the predetermined track.

The tracking error detection method as disclosed in the patent document 3, which employs appropriate five beams, has the same problem as that in the document 1.

The method disclosed in the patent document 2 utilizes a diffraction grating with grid grooves formed on an incident surface and an exiting surface of the light beam so as to form five beam spots on the disk. The beams diffracted on the incident surface are further diffracted on the exiting surface to produce a lot of light beams. These light beams become stray lights, which cannot be avoiding from entering the photodetector, resulting in significantly degraded capability of reproduction of data from the disk.

In the optical disk apparatus, in the seeking operation of the optical pickup device, the object lens for focusing light beams on the disk precedes the pickup. After the movement of the lens, the pickup is moved. This kind of movement of the objective lens is hereinafter referred to as an “objective lens shift”.

In the non-patent document 1, the diffraction grating for adding a phase to sub-light beams is required to be separated in the radial direction of the disk. Thus, the center of the light beam may deviate from the separating line of the diffraction grating in the shift of the objective lens. When an amount of shift of the objective lens is large, the amplitude of the SPP signal occurs, resulting in variations in the amplitude of the tracking error signal. Accordingly, the shift amount of the objective lens must be limited to a small value.

The present invention has been accomplished in view of the above-mentioned problems, and it is an object of the invention to provide an optical pickup device which reduces variations in amplitude of the tracking error signal in the seek and shift operation of the objective lens due to an installation error of the optical pickup device into the optical disk apparatus, thereby generating the tracking error signal with high accuracy without any influence from the stray light, and which is high in productivity and low cost.

To solve the foregoing problems, in one aspect, the invention is directed to an optical pickup device comprising a laser source, a splitting unit for splitting a light beam emitted from the laser source into one main light beam, and a plurality of sub-light beams, an objective lens for focusing the main light beam and the sub-light beams on an optical disk, and a photodetector for receiving reflected light beams of the main light beam and the sub-light beams from the optical disk. The two sub-light beams are focused on at least one of forward and backward sides in a rotational direction of the disk with respect to the mainlight beam focused on the disk. When n is an integer number, and t is a distance between guide grooves of the disk, the two sub-light-beams focused are spaced apart from each other by a distance of t×(n+0.5) in a radial direction of the optical disk. As splitting means for splitting the light beams into a plurality of beams, a diffraction grating is used which has grid grooves spaced apart at equal intervals, but having different angles at the upper and lower parts of an exiting surface of the light beam.

According to the invention, the tracking error signal can be detected with high accuracy, as compared to the prior art.

### BRIEF DESCRIPTION OF THE DRAWINGS

These and other features, objects and advantages of the present invention will become more apparent from the following description when taken in conjunction with the accompanying drawings wherein:

FIGS. 1A and 1B show an optical pickup device, an optical disk, and an arrangement of light spots on the disk according to a first embodiment;

FIG. 2 is a diagram explaining a tracking error signal in the first embodiment;

FIG. 3 is another diagram explaining a tracking error signal in the first embodiment;

FIG. 4 shows an optical disk and an arrangement of spots in the DPP when an objective lens is not off center in the first embodiment;

FIG. 5 shows an optical disk and an arrangement of spots in the DPP when the objective lens is off center in the first embodiment;

FIG. 6 shows an optical disk and an arrangement of spots when the objective lens is not off center in the first embodiment;

FIG. 7 shows an optical disk and an arrangement of spots when the objective lens is off center in the first embodiment;

FIG. 8 is a diagram showing a schematic configuration of an optical pickup device in a second preferred embodiment;

FIGS. 9A and 9B are diagrams explaining a method of splitting a light beam in the second embodiment;

FIGS. 10A and 10B are diagrams explaining a method of splitting a light beam in a third embodiment;

FIG. 11 is a diagram showing a schematic configuration of an optical pickup device in a fourth embodiment;

FIG. 12 is a diagram showing a configuration of an optical disk apparatus in a fifth embodiment;

FIGS. 13A to 13D show arrangements of optical disks, objective lenses, and diffraction gratings in a sixth embodiment;

FIGS. 14A and 14B show detection surfaces on a photodetector and light spots thereon in a seventh embodiment;

FIGS. 15A and 15B show an arrangement of light spots on the optical disk in an eighth embodiment; and

FIGS. 16A and 16B show another arrangement of light spots on the optical disk in the eighth embodiment.

### DETAILED DESCRIPTION OF THE PREFERRED EMBODIMENTS

Reference will now be made to exemplary embodiments of the invention which are illustrated in the accompanying drawings. These embodiments should not be considered to limit the invention.

### First Embodiment

Now, a first embodiment of the invention will be described in detail with reference to the accompanying drawings. Reference will now be made to an optical pickup device for recording or reproducing information on or from a DVD−R (generating a tracking error signal) with a distance between guide grooves set to 0.74 μm. The invention is not limited to the DVD−R, and can be applied to any other recording type optical disk with guide grooves.

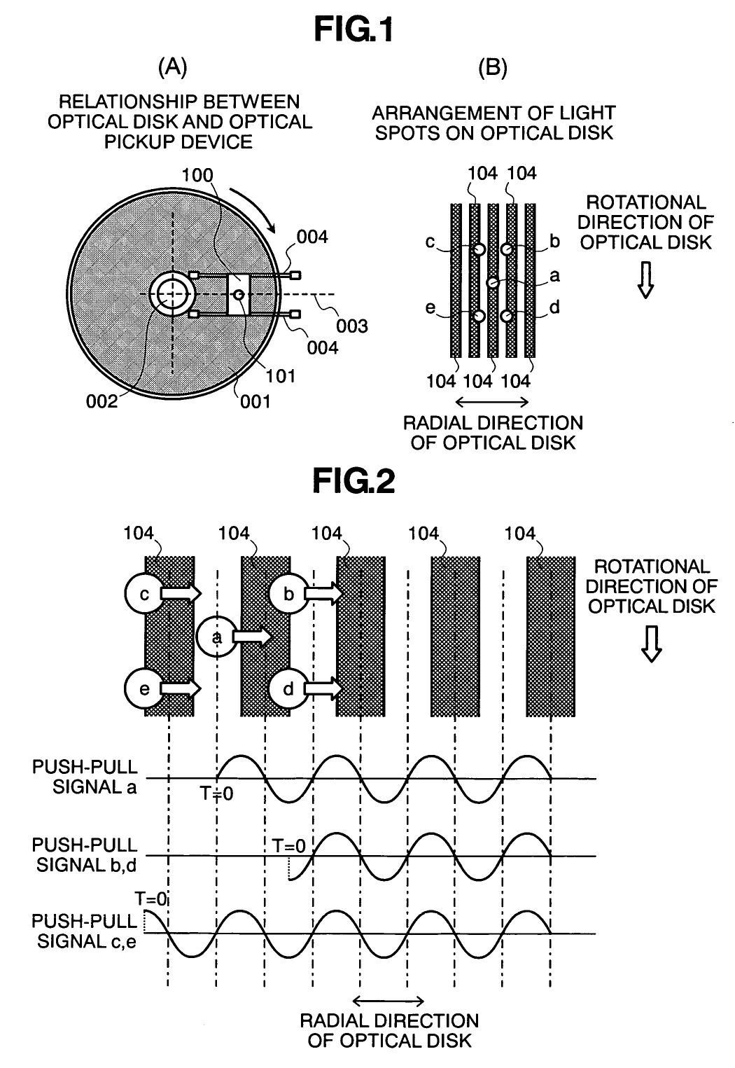

FIGS. 1A and 1B illustrate the optical pickup device, the optical disk, and the light spots on the disk according to the first embodiment. FIG. 1A is a diagram showing a schematic arrangement of the optical disk and the optical pickup device, and FIG. 1B is a diagram showing an arrangement of spots on the optical disk.

First, referring to FIG. 1A, an optical disk 001 has a small hole in its center. In the normal optical disk apparatus, the optical disk 001 is fixed to a spindle 002 via the small hole of the disk 001 as shown in the figure. The spindle 002 has a function of rotating the optical disk 001 with the center of the disk aligned with a rotational shaft. The optical disk 001 rotates in the direction indicated by an arrow in the figure. An optical pickup device 100 is disposed on the reverse side of the optical disk 001. A dotted line 003 is aligned with an axis passing through the center of the optical disk 100 in parallel with the radial direction of the optical disk 100. Normally, the optical pickup device 100 seeks a rail 004 disposed inside the optical disk apparatus. At this time, the seek operation is carried out such that the center of the objective lens 101 in the optical pickup device is aligned with the dotted line 003. Thus, rotating the optical disk 001 by the spindle 002 allows the optical pickup device 100 to seek the disk along the dotted line 003, thereby accessing all data in the optical disk 001.

FIG. 1B is an enlarged view of the optical disk 001, which illustrates an enlarged area including light spots focused on the optical disk 001 by the objective lens 101 of the optical pickup device 100. The optical disk 001 is, for example, the DVD−R. A recording type optical disk, such as the DVD−R, has guide grooves 104 formed thereon. To record information in the guide grooves 104, the pickup device permits the light spots to follow the guide groove 104. The distance between the guide grooves of the DVD−R is 0.74 μm.

In the embodiment, five light spots, namely, a main light spot a, and sub-light spots b, c, d, and e are formed on the optical disk as shown in the figure. The main light spot a is used not only for recording and reproduction of information, but also for generation of a tracking error signal and a focusing error signal. The sub-light spots b, c, d, and e are used for generation of the tracking error signal. The sub-light spots b and c are disposed on the forward side in the rotational direction of the disk with respect to the main light spot a. The sub-light spots b and c are spaced apart from each other by a distance of t×(n+0.5) in the radial direction of the optical disk, wherein n is an integer number, and t is a distance between the guide grooves of the optical disk 001. For n=1, it is supposed in the figure that the light spots b and c are spaced apart from each other by a distance of 1.11 μm (=0.74×(1+0.5)). For n=0, the sub-light spots b and c may be spaced apart from each other by a distance of 0.37 μm.

The sub-light spots d and e are disposed on the backward side in the rotational direction of the optical disk 001 with respect to the main light spot a so as to be spaced apart from each other by the distance of t×(n+0.5), for example, by 1.11 μm, in the radial direction of the optical disk 001, as is the case with the sub-light spots b and c. Although in the figure, the sub-light spots b and c, or the spots d and e are symmetric with respect to the guide groove for the main light spot, the spot c or d may be positioned in the guide groove where the main light spot is disposed, with the distance between the adjacent sub-light spots being spaced apart from each other by the distance t×(n+0.5) in the radial direction of the disk.

Focusing the light spots on the disk in this manner can reduce variations in amplitude of the tracking error signal in the seek operation of the objective lens due to an installation error of the optical pickup device into the optical disk apparatus. This advantage will be described below in detail.

A method for generating the tracking error signal will be described below referring to FIG. 2. FIG. 2 is a diagram explaining the tracking error signal according to the embodiment.

The upper diagram of FIG. 2 shows an enlarged view of the same optical disk as that shown in FIG. 1B, illustrating five light spots in the guide grooves 104.

In general, rotation of the optical disk causes the optical disk to swing in the radial direction of the disk due to eccentricity. Thus, an irradiated point of the light spot on the disk swings largely in the disk radial direction. In the optical disk apparatus, the light spot should follow accurately the predetermined guide groove.

The difference between outputs of the reflected light beams from the optical disk is detected by a photodetector, which includes two parts separated in a direction corresponding to the rotational direction of the optical disk. This provides push-pull signals by the diffracted lights generated in the guide grooves of the optical disk. These push-pull signals are in common use for the optical disk apparatus, and detailed explanation thereof will be omitted.

The arrangement of spots in the figure are obtained when the time T =0. Suppose that the optical spot is moved in the disk radial direction (rightward in the figure) as the time goes by.

When the main light spot a is moved from a position shown in the figure in the radial direction of the optical disk, a push-pull signal a can be detected along the guide groove of the disk as shown in the lower diagram of FIG. 2. From the sub-light spots band d, the push-pull signals band d are obtained. From the sub-light spots c and e, the push-pull signals c and e are obtained. Since the sub-light spots b and d precede the main light spot a by a distance of 0.75×t(0.555 μm) in the disk radial direction, the push-pull signals b and d precede the push-pull signal a by a distance of 0.75×t(0.555 μm). In contrast, since the sub-light spots c and e follow the main light spot a by a distance of 0.75×t(0.555 μm) in the radial direction of the optical disk, the push-pull signals c and e follow the push-pull signal a by a distance of 0.75×t(0.555 μm). That is, the push-pull signals band d precede the push-pull signals c and e by 1.5×t(1.11 μm).

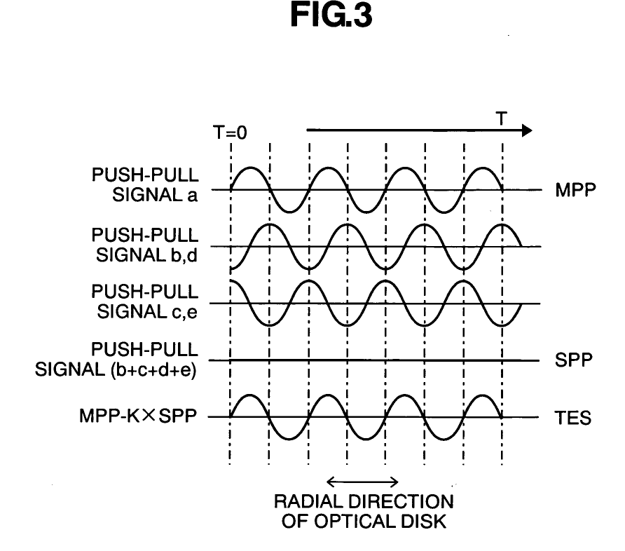

FIG. 3 illustrates signal waveforms of push-pull signals a, b, c, d, and e which are rewritten by evening up the edges of the signal waveforms shown in FIG. 2 at time T=0. It is shown that the push-pull signals b and d precede the push-pull signals c and e by 1.5×t, and thus are in reverse phase thereto. Accordingly, addition of all push-pull signals b, c, d, and e results in an amplitude of zero as shown in the figure.

When MPP is the push-pull signal a, and SPP is an addition value of all push-pull signals b, c, d, and e, the tracking error signal (TES) is obtained by the operation of the following equation 1.
TES=MPP−k×SPP (1)

Note that k is a coefficient for compensating for a difference in the amount of light between the main light spot and the sub-light spots. As shown in the figure, the tracking error signal is equal to the MPP. Since the present operation is the same as that of the DPP method, it has an advantage in that the offset in the shift of the objective lens can be cancelled. In the known DPP method, when the objective lens is off center, an amplitude of the tracking error signal varies between the inner and outer tracks of the disk. This is due to a variation in amplitude of the SPP signal. In the system of the embodiment, however, since the amplitude of the SPP signal is constant at zero, the amplitude variation of the tracking error signal can be reduced.

In the known system as disclosed in the patent documents 1 and 2, a phase is added to each sub-light beam to maintain the amplitude of the SPP signal at constant zero. For example, the amplitude of the push-pull signal b or c is zero. The present system of the embodiment differs from the known system in that the amplitude of the SPP signal is maintained at constant zero by spacing the sub-light spots b and c, and/or the sub-light spots d and e apart from each other by a distance of t×(n+0.5) in the disk radial direction. The present system of the embodiment is different from the known system in the principle of detecting the tracking error signal, and thus has advantages in the shift of the objective lens, as will be described in detail later.

Reference will now be made to the fact that the amplitude of the SPP signal does not vary between the inner and outer tracks of the disk when the objective lens is off center.

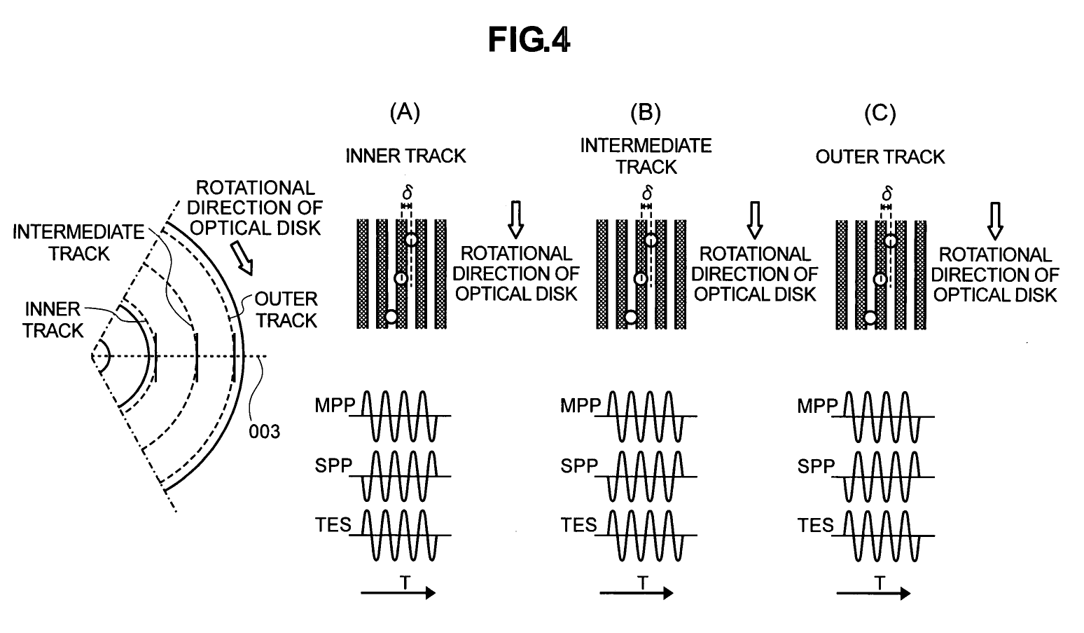

FIG. 4 illustrates the optical disk and the arrangements of DPP spots when the objective lens is not off center. The left diagram illustrates the position of the objective lens on the optical disk, and a tangential direction thereof. It is shown that when the center of the objective lens is identical to the dotted line 003, the tangential line angles of the guide grooves are not different between the inner, intermediate, and outer tracks.

The right diagram illustrates the MPP, SPP, and TES signals obtained from the light spots on the inner, intermediate, and outer tracks of the disk. In the known DPP method, the sub-light spot is spaced apart from the main light spot by a distance of δ=0.5×t. In this arrangement, the SPP signal is in reverse phase to the MPP signal, and the TES signal in phase with the MPP signal is obtained by the operation of the equation 1. It is shown that since the angles of the tangential lines in the guide grooves do not vary among the inner, intermediate, and outer tracks of the disk as shown in the left diagram, the same types of MPP, SPP, and TES signals are generated at any positions of the optical disk.

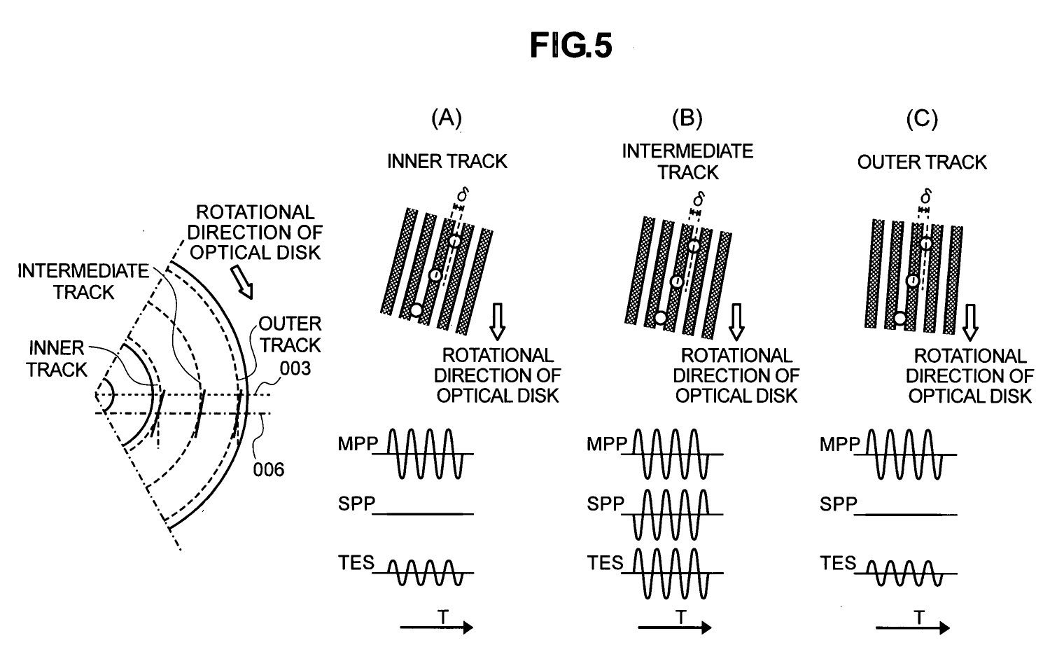

FIG. 5 illustrates the optical disk and the arrangements of DPP spots when the objective lens is off center. The left diagram illustrates the position of the objective lens on the optical disc, and the tangential direction thereof. It is shown that when the center of the objective lens deviates from the dotted line 003, and the objective lens seeks the disk along a dashed line 006, the angle of the tangential line in the corresponding guide groove varies among the inner, intermediate, and outer tracks.

The right diagram illustrates the MPP, SPP, and TES signals obtained from the light spots on the inner, intermediate, and outer tracks of the disk. Like the normal setting of the optical pickup device, in this case, the three DPP spots are appropriately positioned on the intermediate track. First, the three spots on the intermediate track are considered. Since the three spots are positioned appropriately on the intermediate track, the main light spot is spaced apart from the sub-light spots by a distance of δ=0.5×t, whereby the same MPP, SPP, and TES signals as those in FIG. 4 can be detected. On the inner track, although the angles of three spots are not varied, the angle of the tangential line in the guide groove on the disk is varied from that on the intermediate track. A distance between the main light spot and the sub-light spots on the inner track is obviously smaller than the distance δ. Thus, the smaller the distance between the main light spot and the sub-light spots, the smaller the amplitude of the SPP signal becomes. When the distance between the main light spot and the sub-light spots is 0.25×t, the amplification of the SPP signal is eliminated, leading to reduction in amplification of the TES signal by half.

Since the distance between the main light spot and the sub-light spots becomes larger on the outer track, the amplification of the SPP signal is largely decreased as is the case with the inner track. When the distance between the main light spot and the sub-light spots is 0.75×t, the amplification of the SPP signal is eliminated, leading to reduction in amplification of the TES signal by half.

In the known DPP method described above, since the amplification of the TES signal is largely varied when the objective lens is off center, the optical pickup device is required to be mounted on the optical disk apparatus with high accuracy such that the center of the objective lens is not off center.

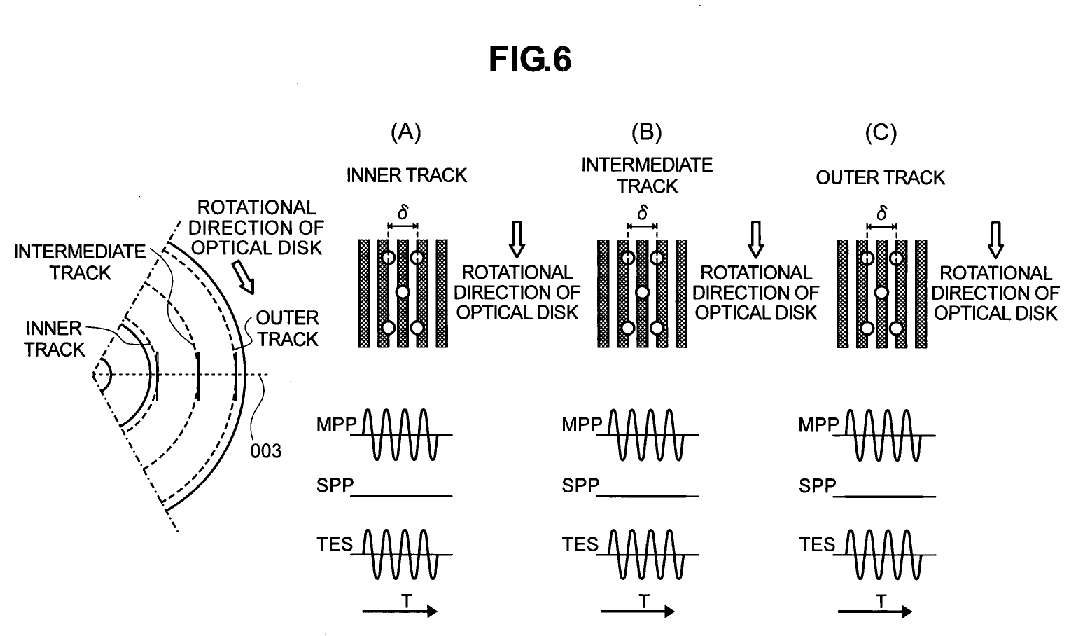

FIG. 6 shows an optical disk and arrangements of spots according to the embodiment when the objective lens is not off center. In the left diagram, the position of the objective lens on the optical disk and the direction of the tangential line are shown. It is shown that when the center of the objective lens is aligned with a dotted line 003, the tangential angle in the guide groove is not varied among the inner, intermediate, and outer tracks.

The right diagram illustrates the MPP, SPP, and TES signals obtained from the light spots on the inner, intermediate, and outer tracks of the disk. In the method for detection of the tracking error signal in the embodiment, two sub-light spots preceding or following the main-light spot are spaced from each other by a distance of δ=t×(n+0.5). With this arrangement, the amplitude of the SPP signal is eliminated, and the TES signal obtained by the operation of the equation 1 is in phase with the MPP signal. It is shown that as shown in the left diagram, since the tangential angle of the guide groove is not varied among the inner, intermediate, and outer tracks, the same MPP, SPP, and TES signals are generated at any points on the optical disk.

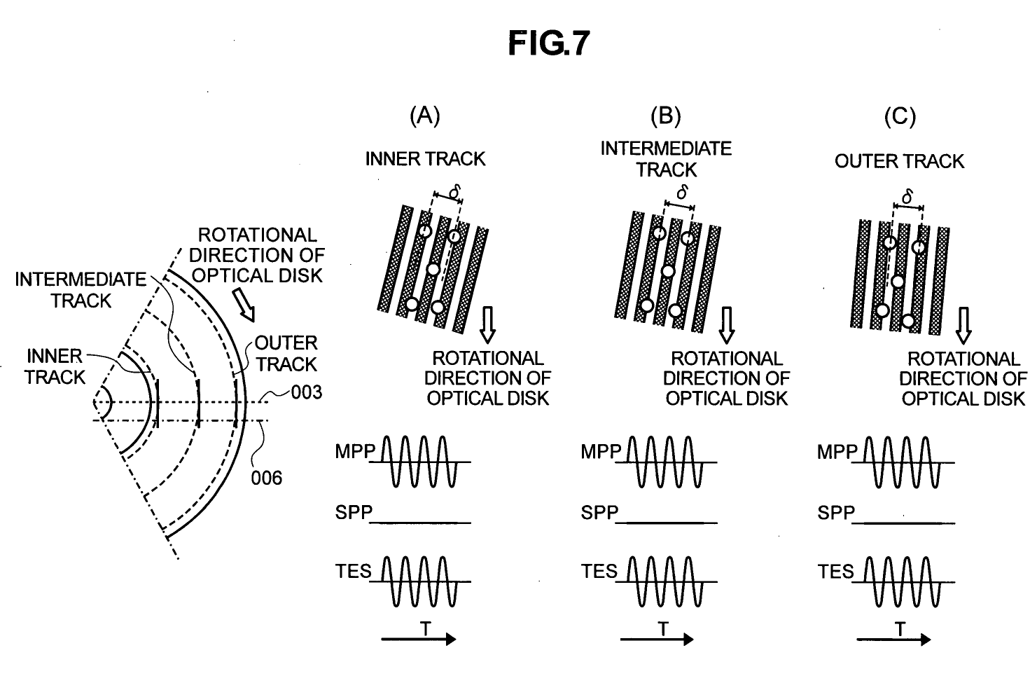

FIG. 7 illustrates the optical disk and the arrangements of spots when the objective lens is off center in the embodiment. The left diagram illustrates the position of the objective lens on the optical disc, and the tangential direction thereof. It is shown that when the center of the objective lens deviates from the dotted line 003, and the objective lens seeks the disk along a dashed line 006, the angle of the tangential line in the corresponding guide groove varies among the inner, intermediate, and outer tracks.

The right diagram illustrates the MPP, SPP, and TES signals obtained from the light spots on the inner, intermediate, and outer tracks of the disk. Like the normal setting of the optical pickup device, in this case, the five spots are appropriately positioned on the intermediate track. First, the spots on the intermediate track are considered. Since the five spots are positioned appropriately on the intermediate track, the same MPP, SPP, and TES signals as those shown in FIG. 6 can be detected.

On the inner track of the disk, the angle of the guide groove on the disk is varied. However, a distance between the two sub-light spots preceding or following is not varied so much, and maintained at about δ=t×(n+0.5). Thus, even if the lens seeks the inner track of the disk, the same MPP, SPP, and TES signals as those on the intermediate track can be detected.

Likewise, also on the outer track of the disk, the same MPP, SPP, and TES signals as those on the intermediate and inner tracks can be detected.

Accordingly, in the detection method of the tracking error signal of the embodiment, the constant TES signal can be obtained regardless whether the objective lens is off center or not.

This eliminates the necessity of mounting the optical pickup device on the optical disk apparatus with high accuracy so that the center of the objective lens is not off center, thereby simplifying the assembly steps.

In the known DPP, it is necessary to control the rotation of the diffraction grating with high accuracy so as to form three beams by the grating in the optical pickup device. However, in the method for generating the tracking error signal not depending on the rotational angle according to the invention, adjustment of the rotation of the diffraction grating is not required, and the simple assembly steps of the optical pickup device can be achieved.

### Second Embodiment

In a second embodiment, an optical pickup device for generating the tracking error signal of the first embodiment will be described below. An optical pickup device applicable for recording and reproducing information on the DVD−R is taken as an example in the second embodiment below. Note that the invention is not limited to the optical pickup device for the DVD−R, and may be applied to any other recording type optical disk with guide grooves.

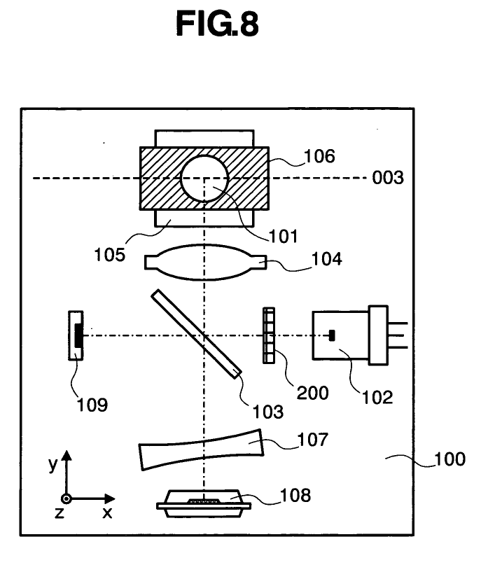

FIG. 8 illustrates a schematic configuration of an optical pickup device 100. The dashed line in the figure shows a light path of a light beam. The dotted line 003 in the figure is an axis passing through the center of the disk 100 in parallel to the radial direction of the optical disk.

In recording or reproducing information on or from the optical disk, such as a DVD, a semiconductor laser 102 with a wavelength band of 660 nm is usually used. The light beam with a wavelength of about 660 nm is emitted as a divergent ray from the semiconductor laser 102. The light beam emitted from the semiconductor laser 102 enters a splitting element 200, which maybe a diffraction grating. The light beam is split into five beams by the splitting element 200. The details of the splitting element 200 will be described later. The light beams passing through the splitting element 200 are reflected from a beam splitter 103, and then is converted into substantially parallel light beams by a collimator lens 104. Parts of the light beams pass through the beam splitter 103 to enter a front monitor 109. In general, when information is recorded on the recording type optical disk, such as the DVD−R, in order to irradiate the recording surface of the optical disk with the light with a predetermined intensity, it is necessary to control the emission intensity of the semiconductor laser with high accuracy. For this reason, when signals are recorded on the recording type optical disk, the front monitor 109 detects variations in emission intensity of the semiconductor laser 102, which are fed back to a driving circuit (not shown) of the semiconductor laser 102.

The light beams exiting the collimator lens 104 are applied to and focused on the optical disk by the objective lens 101 mounted on an actuator 106 to form five light spots on the disk. The light beams are reflected from the optical disk, and pass through the object lens 101, the collimator lens 104, the beam splitter 103, and a detection lens 107 to reach a photodetector 108. The astigmatism is given to the light beams when passing through the beam splitter 103. The light beams are used for detection of the focus error signal (hereinafter referred to as FES signal). The detection lens 107 has functions of rotating the direction of astigmatism in an arbitrary direction, and of determining the size of focused light spots on the photodetector 108. The light beams introduced into the photodetector 108 are used for detection of information signals recorded on the optic disk, and for detection of a position control signal for controlling the position of the focused light spot on the disk, such as a TES signal or a FES signal.

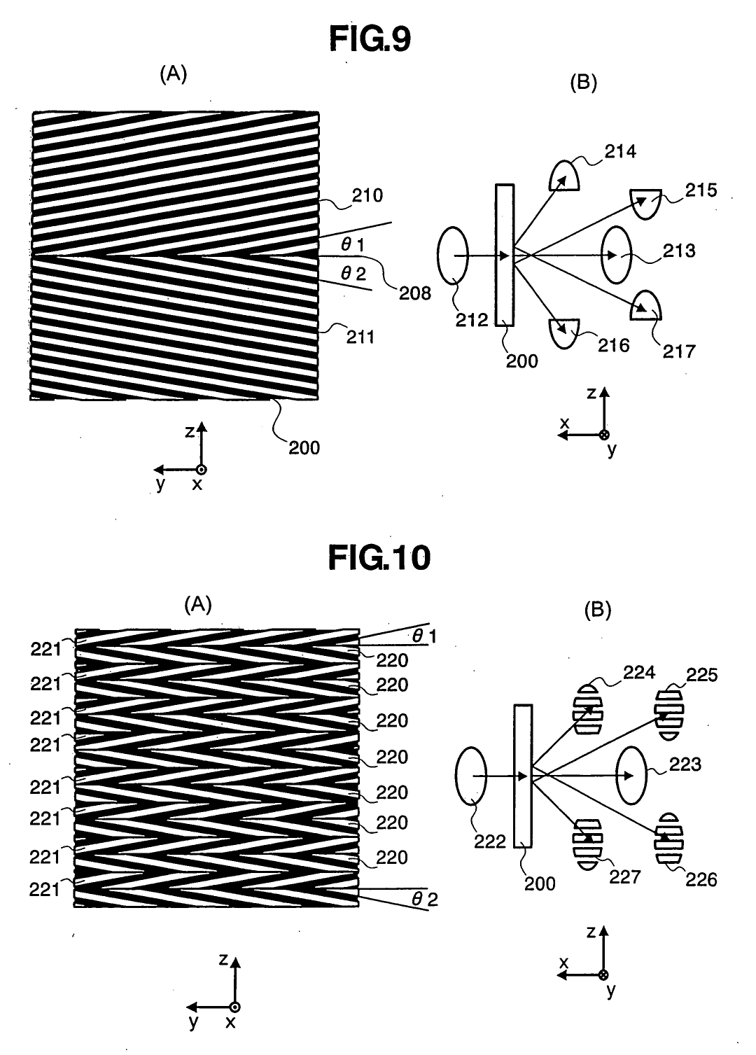

Now, a method for splitting the light beam into five beams will be explained below with reference to FIGS. 9A and 9B. FIG. 9A shows a schematic configuration of the splitting element 200, as seen from the beam splitter side. The splitting element 200 is a diffraction gating for diffracting the light beam. The splitting element 200 has two areas, namely, an upper part 210 and a lower part 211 which are separated by a separating line 208, on its exiting surface of the light beam. These areas have grid grooves spaced at equal intervals. The grid groove formed at the upper part 210 has an angle of θ1, while the grid groove formed at the lower part 211 has an angle of θ2 other than the angle θ1. It should be noted that the y direction is a direction corresponding to the radial direction of the optical disk. As shown in the figure, the element 200 is divided in a direction orthogonal to the y direction as shown in the figure, and thus has the effect that the difference in distribution of intensity due to the shift of the objective lens is eliminated.

FIG. 9B schematically shows the split of the light beam by the splitting element 200. The light beam enters the element 200 such that the separating line 208 of the diffraction grating is aligned with the center of the light beam 212. The incident light beam 212 can be split into five light beams, namely, a 0-th light beam 213 passing through the element without being diffracted, an upper +1-st order diffracted light beam 214 and an upper −1-st order diffracted light beam 217 positioned at the upper half part of the beam, and a lower +1-st order diffracted light beam 215 and a lower −1-st order diffracted light beam 216 positioned at the lower half part of the beam. Since the light beams are respectively diffracted individually at the upper and lower parts, this diffraction grating has an advantage in that it does not have any influence from stray lights, which might be caused by two laminated diffraction gratings as disclosed in the patent document 2.

In the embodiment, among the five light beams, the 0-th light beam 213 forms a main light spot a, the upper +1-st order diffracted light beam 214 forms a sub-light spot b, the lower +1-st order diffracted light beam 215 forms a sub-light spot c, the upper −1-st order diffracted light beam 217 forms a sub-light spot e, and the lower −1-st order diffracted light beam 216 forms a sub-light spot d. This can reduce variations in amplitude of the tracking error signal even if the objective lens is off center. The use of this splitting element eliminates the necessity of adjustment of rotation of the element itself, thereby readily assembling the optical pickup device.

Further, since the distance between the grid grooves at the upper part 210 is the same as that at the lower part 211, a detection surface pattern on the photodetector can be advantageously used in the known opto-electronic integrated circuit (OEIC). It is understood that the distances between the grid grooves at the upper and lower parts 210 and 211 may be changed by increasing the detection surface pattern.

Although in the second embodiment, a light path from the beam splitter 103 to the objective lens 108 is straight, the invention is not limited thereto. An optical component, such as a mirror or a prism, may be disposed in the light path to bend the path.

### Third Embodiment

Another splitting element according to a third embodiment that is different from the splitting element 200 of the second embodiment will be described below. The third embodiment differs from the second embodiment only in the use of a splitting element 201, and other components of the third embodiment are the same as those of the second embodiment. The explanation of the same or like components will be omitted below. Referring to FIGS. 10A and 10B, the splitting element 201 for splitting the light beam into five beams will be described below in detail. FIG. 10A shows a schematic configuration of the splitting element 201, as seen from the beam splitter side. The splitting element 201 is a diffraction gating for diffracting the light beam. The splitting element 201 has two areas alternately arranged in the z direction on its exiting surface for the light beam, namely, a part 221 with grid grooves having an angle of θ1, and a part 220 with grid grooves having an angle of of θ2 other than the angle θ1. As shown in the figure, the element 201 is divided in a direction orthogonal to the y direction, and thus has an advantage in that the difference in distribution of intensity due to the shift of the objective lens is eliminated.

FIG. 10B schematically shows the split of light beam by the splitting element 201. An incident light beam 222 can be split into five light beams. More specifically, a part of the incident light beam 222 is a 0-th light beam 223 which passes through the element without being diffracted. The light beam passing through the area 221 is split into a +1-st order diffracted light beam 224 and a −1-st order diffracted light beam 226. The light beam passing through the area 220 is split into a +1-st order diffracted light beam 225 and a −1-st order diffracted light beam 227. Since the light beams are respectively diffracted individually at the areas 220 and 221, this diffraction grating has an advantage in that it does not have any influence from stray lights, which might be caused by two laminated diffraction gratings as disclosed in the patent document 2. Further, the grating of the third embodiment is separated into multiple parts, and not two parts as described in the second embodiment, thereby eliminating the necessity of aligning the center of the incident light beam 222 with the center of the splitting element 201, further simplifying the assembly steps as compared to the case of the embodiment 2.

Among the five light beams generated, the 0-th light beam 223 forms a main light spot a, the +1-st order diffracted light beam 224 forms a sub-light spot b, the +1-st order diffracted light beam 225 forms a sub-light spot c, the −1-st order diffracted light beam 226 forms a sub-light spot e, and the −1-st order diffracted light beam 227 forms a sub-light spot d. This can reduce variations in amplitude of the tracking error signal even if the objective lens is off center.

The use of this splitting element eliminates the necessity of adjustment of rotation of the element itself, thereby readily assembling the optical pickup device.

### Fourth Embodiment

Now, a configuration of a specific optical pickup device according to the fourth embodiment, which is capable of using a method for generation of a tracking error signal of the invention, will be described in detail. The pickup device explained herein is an optical pickup device having compatibility between the Blu-ray and the DVD.

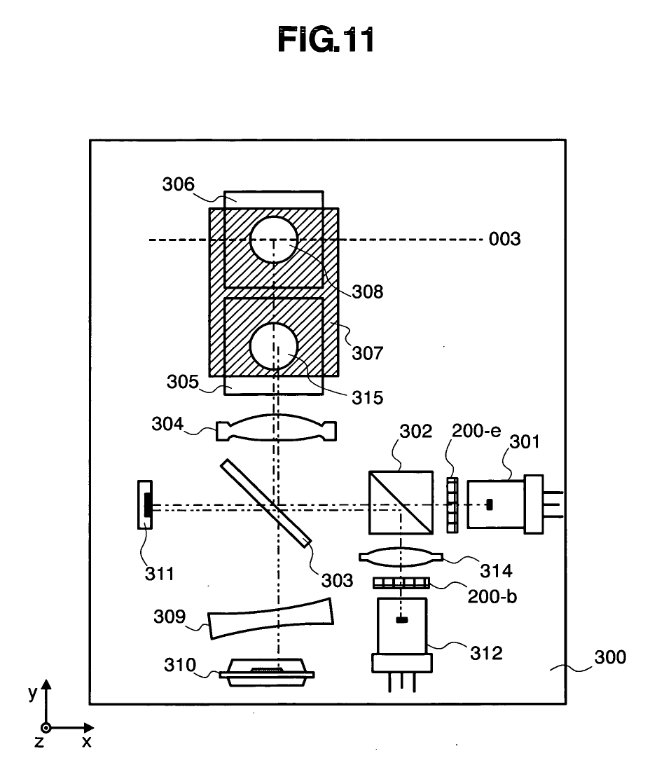

FIG. 11 is a diagram showing a schematic structure of an optical pickup device 300. The dashed line in the figure indicates a light path of a light beam for the Blu-ray, while the double-dashed line in the figure indicates a light path of a light beam for the DVD. The dotted line 003 is an axis passing through the center of the optical disk in parallel to the radial direction of the disk. Note that although in the optical system of the fourth embodiment, the objective lens for the Blue-ray seeks to be aligned with the dotted line 003, the DVD may be aligned with the dotted line 003.

First, the Blue-ray optical system will be described below. In recording or reproducing information on or from the Blur-ray disk, a semiconductor laser with a wavelength band of 405 nm is normally used. The light beam with a wavelength of about 405 nm is emitted as a divergent ray from a BD semiconductor laser 301. The light beam emitted from the BC semiconductor laser 301 enters a splitting element 200-a. The splitting element 200-a may be a diffraction grating with the same grid groove pattern as that of the splitting element 200 as explained in the second embodiment. The light beam is split into five beams by the splitting element 200-a. Unlike the splitting element 200, the diffraction grating of the splitting element 200-a are set such that a distance between the grid grooves is tb×(n+0.5) in the disk radial direction when tb is a distance between the guide grooves of the Blue-ray disk. The light beams passing through the splitting element 200-a pass through a beam splitter 302, are reflected from a beam splitter 303, and are converted into substantially parallel light beams by a collimator lens 304. It should be noted that parts of the light beams pass through the beam splitter 303 to enter a front monitor 311. When signals are recorded on the optical disk, the front monitor 311 detects variations in emission intensity of the BD semiconductor laser 301, which are fed back to a driving circuit (not shown) of the BD semiconductor laser 301.

The light beams exiting the collimator lens 304 pass through a standing mirror 305, and are reflected by a standing mirror 306 in the Z direction of the figure. Then, the light beams are focused on the disk by an objective lens 308 for BD mounted on an actuator 307 to form five spots formed on the disk.

The actuator 307 installs thereon two objective lenses, that is, the objective lens 308 for BD, and the objective lens 315 for DVD, and is capable of simultaneously driving the two objective lenses.

The light beams reflected from the optical disk pass through the objective lens 308 for BD, the standing mirror 306, the standing mirror 305, the collimator lens 304, the beam splitter 303, and a detection lens 309, to reach a photodetector 310. The astigmatism is given to the light beams when passing through the beam splitter 303. The light beams are used for detection of the focus error signal (hereinafter referred to as FES signal). The detection lens 309 has functions of rotating the direction of astigmatism in an arbitrary direction, and of determining the size of focused light spot on the photodetector 310. The light beams introduced into the photodetector 310 are used for detection of information signals recorded on the optical disk, and for detection of a position control signal for controlling the position of the focused light spot on the disk, such as a TES signal or a FES signal.

Any other detection surface pattern on the photodetector 310 may be employed which enable detection of information signals recorded on the optical disk, and detection of the TES and FES signals.

Reference will now be made to the DVD optical system. In recording or reproducing information on or from the DVD disk, a semiconductor laser with a wavelength band of 660 nm is normally used. The light beam with a wavelength of about 660 nm is emitted as a divergent ray from a DVD semiconductor laser 312. The light beam emitted from the DVD semiconductor laser 312 enters a splitting element 200-b, which may be a diffraction grating with the same grid groove pattern as that of the splitting element 200 as explained in the second embodiment. The light beam is split into five beams by the splitting element 200-b. Unlike the splitting element 200, the diffraction grating of the splitting element 200-b are set such that a distance between the grid grooves of the diffraction grating is td×(n+0.5) in the disk radial direction when td is a distance between the guide grooves of the DVD−R disk.

The light beams passing through the splitting element 200-b enters a correcting lens 314. The Blu-ray system is different from the DVD system in an optical magnification (the focal distance of the collimator lens÷the focal distance of the objective lens). Thus, in the DVD optical system, providing the correcting lens 314 can set a magnification of the lens different from that in the Blu-ray optical system.

The light beams passing through the correcting lens 314 are reflected from the beam splitter 302 and the beam splitter 303, and is converted into substantially parallel light beams by the collimator lens 304. Parts of the light beams pass through the beam splitter 303 to enter the front monitor 311. When signals are recorded on the optical disk, the front monitor 311 detects variations in emission intensity of the DVD semiconductor laser 312, which are fed back to a driving circuit (not shown) of the semiconductor laser 312.

The light beams exiting the collimator lens 304 are reflected by the standing mirror 305 in the Z direction of the figure, and then focused on the disk by the objective lens 315 mounted on the actuator 307 to form five spots formed on the disk. The light beams reflected from the optical disk pass through the objective lens 315, the collimator lens 304, the beam splitter 303, and the detection lens 309 to reach a photodetector 310. The light beams introduced into the photodetector 310 are used for detection of information signals recorded on the optic disk, and for detection of a position control signal, such as a TES signal or a FES signal, for controlling the position of the focused light spot on the disk.

As mentioned above, even in the optical system including two objective lens arranged in the direction orthogonal to the disk radial direction as shown in the figure, the detecting method of the tracking error signal as disclosed in the first embodiment may be applied to enable the accurate tracking.

### Fifth Embodiment

Reference will now be made to an optical disk apparatus according to a fifth embodiment which is equipped with the optical pickup device as described above.

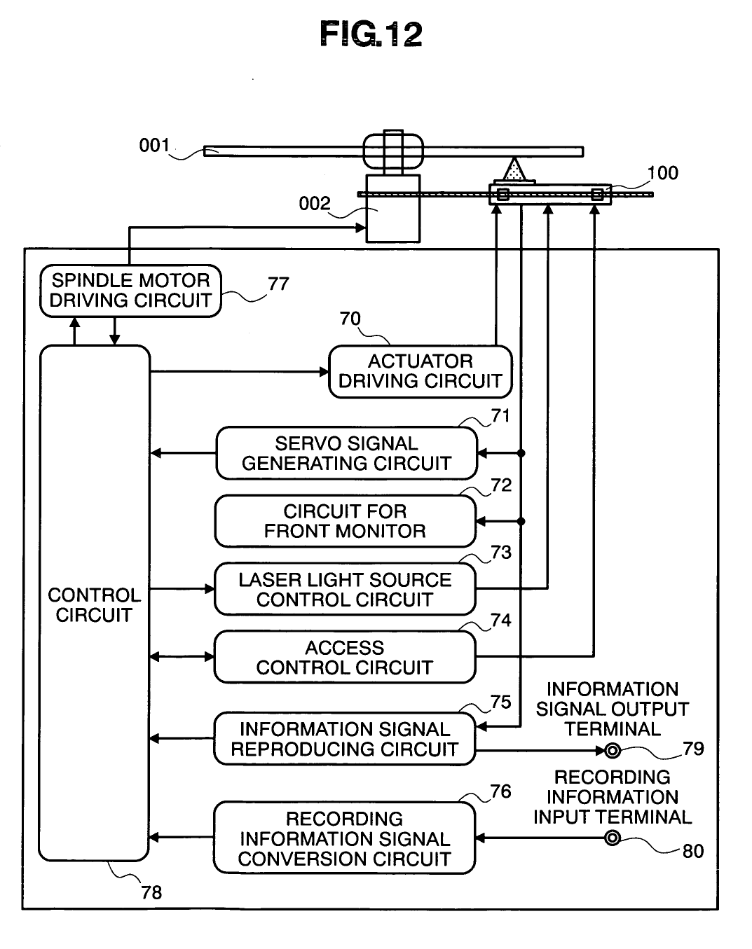

FIG. 12 is a schematic block diagram of an optical disk apparatus for recording and reproducing information, which is equipped with the optical pickup device 100. Signals detected by the optical pickup device 100 are fed to a servo signal generating circuit 71 within a signal processing circuit, a circuit for a front monitor 72, and an information signal reproducing circuit 75. The servo signal generating circuit 71 generates FES and TES signals appropriate for each optical disk from these detection signals, based on which an actuator for the objective lens within the optical pickup device 100 is driven via the actuator driving circuit 70 to control the position of the objective lens. The circuit for the front monitor 72 detects a monitor signal indicative of the amount of light of the laser source from the detection signals supplied from the front monitor. Based on the monitor signal, the front monitor circuit drives a laser light source control circuit 73 to accurately control the amount of light on the optical disk 001. The information signal reproducing circuit 75 reproduces information signals recorded on the optical disk 001 from the detection signals, and outputs the information signals reproduced to an information signal output terminal 79.

When recording information is input from the recording information input terminal 80, the recording information signal conversion circuit 76 converts the recording information into a predetermined recording signal for driving the laser. The recording signal for laser driving is fed to the control circuit 78, where the laser light source control circuit 73 is driven to control the amount of light from the laser source, thereby recording the recording signals on the optical disk 001. The control circuit 78 is connected to the access control circuit 74 and the spindle motor driving circuit 77, and which controls the position of the optical pickup device 1 in the access direction, and the rotation of the spindle motor 002 of the optical disk 001.

Although in the embodiment, the optical pickup device and optical disk apparatus correspond to the DVD−R, the invention is not limited thereto. For example, the optical pickup device and optical disk apparatus may be used for any other optical disks, including a compact disk, a DVD-RAM, a DVD+R, and an optical disk with higher density than the DVD using a blue semiconductor laser.

### Sixth Embodiment

The superiority of generation of the tracking error when the objective lens is shifted in a sixth embodiment will be described hereinafter in detail.

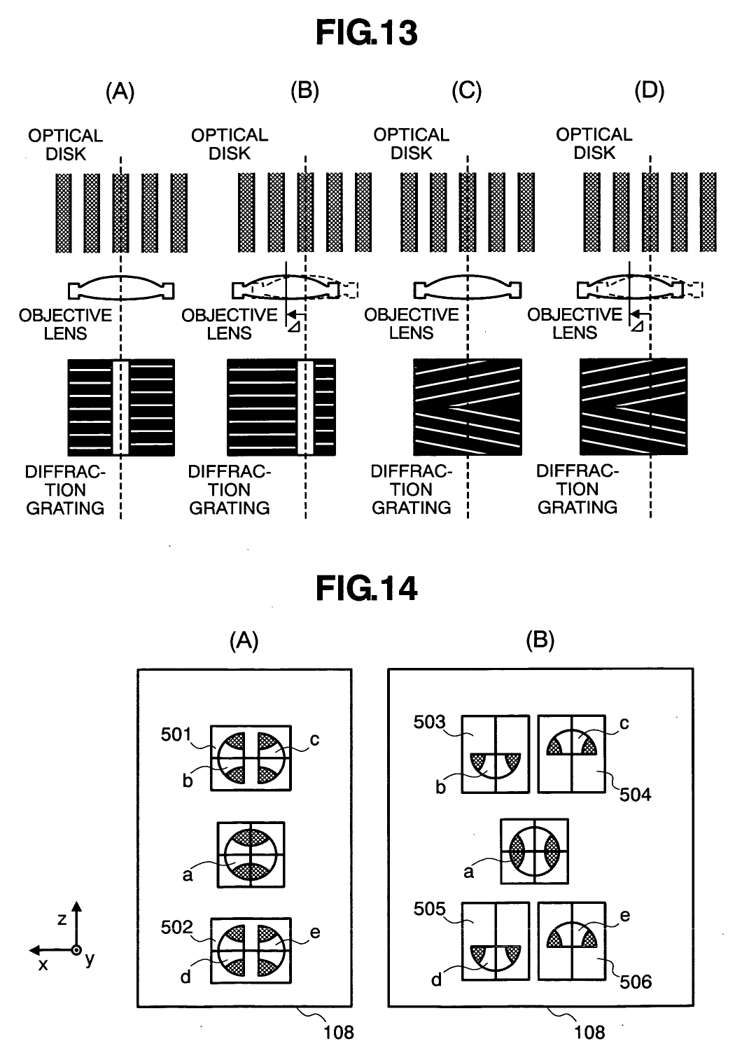

FIGS. 13A to 13D show arrangements of the optical disk, the objective lens, and the diffraction grating. FIG. 13A shows a diffraction grating when the objective lens is not shifted, as disclosed in the non-patent document 1, FIG. 13B shows the diffraction grating when the objective lens is shifted as disclosed in the non-patent document 1, FIG. 13C shows a diffraction grating of the second embodiment when the objective lens is not shifted, and FIG. 13D shows the diffraction grating of the second embodiment when the objective lens is shifted.

The diffraction grating of the non-patent document 1 as shown in FIG. 13A is separated into areas in the disk radial direction. These areas divided have different phases to thereby eliminate the PP signals of the sub-light beams. In use of such a diffraction grating, when the objective lens is shifted in the disk radial direction as shown in FIG. 13B, the deviation Δ of the center of the objective lens from the center of the diffraction grating causes the phase added to the sub-light beam to be shifted. Thus, when the object lens is shifted, the PP signals of the sub-light beams are not eliminated, resulting in variations in the tracking error signal in the lens shift.

FIG. 13C illustrates the diffraction grating of the embodiment, which does not add a phase to the sub-light beam, and divides the light beam. For this reason, the grating has parts separated in the direction orthogonal to the disk radial direction. Accordingly, the embodiment has a large advantage in that the deviation of the center of the objective lens from the separating line does not occur even when the objective lens is shifted by Δ as shown in FIG. 13D, thereby stably detecting the tracking error signal with high accuracy in the shift of the objective lens.

### Seventh Embodiment

Reference will now be made to an effect of combination of the known system for generating the focus error signal in the astigmatism system and a method for generating the tracking error signal in the present embodiment.

FIGS. 14A and 14B illustrate a detection surface of the photodector 108, and light spots. FIG. 14A shows a state in which the distribution of intensity of the light spots is rotated on the photodetector 108 by 90 degrees by the detection lens 107, and FIG. 14B shows a state in which the distribution thereof is not rotated. In the embodiment, the generation of the focus error signal is carried out using the astigmatism method as shown in FIG. 14A, in which the distribution of intensity of the light spots is rotated on the photodetector by 90 degrees. Thus, a ball-shaped surface of the main light spot a with the diffracted light by the optical disk is symmetric with respect to the z direction. Also, the sub-light spots b, c, d, and e form the ball-shaped surfaces in the z direction in the same manner. Thus, the ball-shaped surfaces of the sub-light spots b and c with the diffracted light by the optical disk are symmetric with respect to the detection surface 501 separated into two parts. That is, the sub-light spots b and c can provide the push-pull signals b and c, respectively, from the same detection surface 501. Similarly, the sub-light spots d and e can provide the push-pull signals d and e from the same detection surface 502.

When the distribution of intensity of the light spots is not rotated as shown in FIG. 14B, the ball-shaped surface of the main light spot a with the diffracted light by the disk is symmetric in the x direction. Also, as to the sub-light spots b, c, d, and e, the ball-shaped surfaces are formed in the x direction. Thus, since the sub-light spots b and c cannot provide the push-pull signals from the same detection surface, the sub-light spots b and c need the two detection surfaces 503 and 504 divided, respectively. Likewise, the sub-light spots d and e need the two detection surfaces 505 and 506 divided, respectively. Thus, in the case shown in FIG. 14B, two detection surface parts are added so as to detect the necessary push-pull signals, as compared to the case shown in FIG. 14A.

By rotating the intensity distribution of the light spots on the photodetector by 90 degrees by the astigmatism method, the known simplest eight-divided detection surfaces can be used as the detection surface pattern of the photodetector as shown in FIG. 14A, which is an advantage.

### Eighth Embodiment

Reference will now be made to an optical pickup device suitable for the DVD−R (0.74 μm) and the DVD-RAM (1.23 μm) which have different distances between guide grooves.

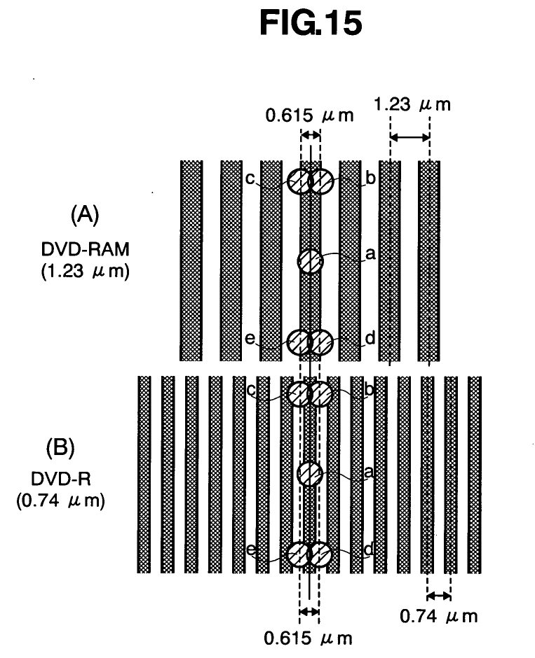

FIGS. 15A and 15B illustrate arrangements of light spots which are applied to the DVD−R and DVD-RAM. FIG. 15A shows, the DVD-RAM with the guide groove distance of 1.23 μm, and FIG. 15B shows the DVD−R with the guide groove distance of 0.74 μm.

As shown in FIG. 15A, five light spots, namely, the main spot a and the sub-light spots b, c, d, and e are disposed on the DVD-RAM. The sub-light spots b and c are disposed forward of the main spot a in the rotational direction of the optical disk, while the sub-light spots d and e are disposed backward of the main spot a. In the figure, a set of the sub-light spots b and c, and a set of the sub-light spots d and e respectively satisfy the relationship t×(n+0.5) in the disk radial direction when t=1.23 μm, and n=0. That is, the sub-light spots b and c are spaced apart from each other by 0.615 μm in the disk radial direction, and the sub-light spots d and e are also spaced apart from each other by 0.615 μm in the disk radial direction. Thus, as mentioned above in the first and second embodiments, the pickup device according to the embodiments can detect the constant TES signal regardless of the off center of the pickup device when the light spots are focused on the optical disk.

FIG. 15B illustrates five light spots focused on the DVD−R, namely, the main spot a and the sub-light spots b, c, d, and e which are the same as those shown in FIG. 15A. As is the case with FIG. 15A, the sub-light spots b and c are spaced apart from each other by 0.615 μm in the disk radial direction. Much the same is true on the sub-light spots d and e.

For the DVD−R (0.74 μm), however, the sub-light spots b and c are spaced apart from each other in the disk radial direction so as to satisfy the relationship t×(n+0.5). Much the same is true on the sub-light spots d and e. For example, the distance between these sub-light spots needs to be 0.37 μm for n=0, or 1.11 μm for n=1. If the sub-light spots b and c, or the sub-light spots d and e are spaced apart from each other only by 0.615 μm in the disk radial direction, the stable TES signal cannot be detected from the DVD−R.

That is, if the light spots are focused on the disk as shown in FIGS. 15A and 15B, one optical pickup device cannot deal with both the DVD−R and DVD-RAM.

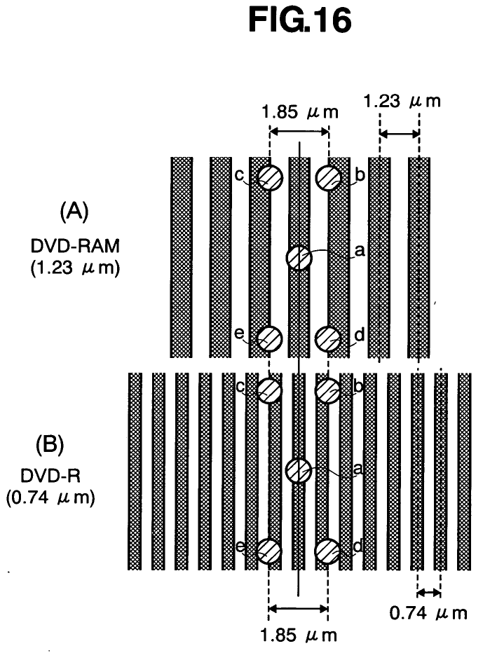

FIGS. 16A and 16B illustrate arrangements of light spots which are applied to the DVD−R and DVD-RAM. FIG. 16A shows the DVD-RAM with the guide groove distance of 1.23 μm, and FIG. 16B shows the DVD−R with the guide groove distance of 0.74 μm. FIGS. 16A and 16B illustrate a state in which the distance between the sub-light spots b and c, and the distance between the sub-light spots d and e are different from those in FIGS. 15A and 15B.

As shown in FIG. 16A, five light spots, namely, the main spot a and the sub-light spots b, c, d, and e are arranged on the DVD-RAM. The sub-light spots b and c are disposed forward of the main spot a in the rotational direction of the optical disk, while the sub-light spots d and e are disposed backward of the main spot a. In the figure, a set of the sub-light spots b and c, and a set of the sub-light spots d and e respectively satisfy the relationship t×(n+0.5) in the disk radial direction when t=1.23 μm, and n=1. That is, the sub-light spots b and c are spaced apart from each other by 1.85 μm in the disk radial direction, and the sub-light spots d and e are also spaced apart from each other by 1.85 μm in the disk radial direction. Thus, as mentioned above in the first and second embodiments, the pickup device according to the embodiments can detect the constant TES signal regardless of the off center of the pickup device when the light spots are focused on the optical disk.

FIG. 16B illustrates five light spots focused on the DVD−R, namely, the main spot a, and the sub-light spots b, c, d, and e which are the same as those shown in FIG. 16A. As is the case with FIG. 16A, the sub-light spots b and c are spaced apart from each other by 1.85 μm in the disk radial direction. Much the same is true on the sub-light spots d and e. This value substantially corresponds to a case in which the relationship is t×(n+0.5), n=2, for the DVD−R (0.74 μm).

It is shown that the TES signal can be detected constantly from two disks, for example, the DVD−R (0.74 μm) and the DVD−RAM (1.23 μm), with different guide groove distances, regardless whether the optical pickup device is off center or not. The arrangement of spots as shown in FIGS. 16A and 16B can provide an optical pickup device that is capable of recording/reproducing both the DVD−R and the DVD-RAM. This optical pickup device suitable for the DVD−R or DVD-RAM has advantages in achieving simple assembly steps which eliminates the necessity of adjustment of rotation of the diffraction grating, and of alignment of the center of the objective lens when it is mounted on the optical disk apparatus.

As mentioned above, the distances between the sub-light spots b and c, and between the sub-light spots d and e are respectively set to about 1.85 μm in the disk radial direction, whereby the optical pickup device suitable for both the DVD−R and DVD-RAM with the different guide groove distances can be achieved.

In the same principle, the distances between the sub-light spots b and c, and between the sub-light spots d and e are respectively set to about 1.85 μm in the disk radial direction, whereby the optical disk apparatus suitable for the DVD−R and DVD-RAM with the different guide groove distances can be provided.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. An optical pickup device comprising:
a laser source;
a splitting unit for splitting a light beam emitted from the laser source into one main light beam and a plurality of sub-light beams;
an objective lens for focusing the main light beam and the sub-light beams on an optical disk; and
a photodetector for receiving reflected light beams of the main light beam and the sub-light beams from the optical disk,
wherein the two sub-light beams are focused on at least one of forward and backward sides in a rotational direction of the disk with respect to the main light beam focused on the disk, and
wherein, when n is an integer number, and t is a distance between guide grooves of the disk, the two sub-light beams focused are spaced apart from each other by a distance of t×(n+0.5) in a radial direction of the optical disk.

2. The optical pickup device according to claim 1,
wherein the photodetector includes at least two detection areas for receiving the reflected light beam of the main light beam from the optical disk, and for receiving the reflected light beams of the two sub-light beams from the optical disk,
wherein each of the two detection areas has at least two receiving surfaces separated in a predetermined direction corresponding to the radial direction of the disk, and
wherein a signal is output to enable to generate a tracking error signal from a difference between signals individually detected at the two receiving surfaces by a push-pull system, in each detection area.

3. An optical pickup device comprising:
a laser source;
a splitting unit for splitting a light beam emitted from the laser source into one main light beam and a plurality of sub-light beams;
an objective lens for focusing the main light beam and the sub-light beams on an optical disk; and
a photodetector for receiving reflected light beams of the main light beam and the sub-light beams from the optical disk,
wherein the at least two sub-light beams are focused on forward and backward sides in a rotational direction of the disk with respect to the main light beam focused on the disk, and
wherein, when n is an integer number, and t is a distance between guide grooves of the disk, the two sub-light beams disposed on each of the forward and backward sides are spaced apart from each other by a distance of t×(n+0.5) in a radial direction of the optical disk.

4. The optical pickup device according to claim 3, wherein the photodetector includes at least three detection areas for respectively receiving the reflected light beam of the main light beam from the optical disk, the reflected light beams of the two sub-light beams from the disk focused on the forward side in the rotational direction of the disk with respect to the main light beam, and the reflected light beams of the two sub-light beams from the disk focused on the backward side in the rotational direction of the disk with respect to the main light beam, wherein each of the three detection areas has at least two receiving surfaces separated in a predetermined direction corresponding to the radial direction of the disk, and wherein a signal is output to enable generation of a tracking error signal from a difference between signals individually detected at the two receiving surfaces by a push-pull system, in each detection area.

5. A diffraction grating for splitting a light beam into a plurality of beams, wherein the grating has grid grooves spaced at equal intervals on incident and exiting surfaces of the light beam, an angle of the grid groove on the exiting surface being different from that of the grid groove on the incident surface.

6. A diffraction grating for splitting a light beam into a plurality of beams, wherein the grating has grid grooves spaced at equal intervals, but having different angles at upper and lower parts of an exiting surface of the light beam.

7. A diffraction grating for splitting a light beam into a plurality of beams, wherein the grating has a plurality of areas spaced at equal intervals at upper and lower parts of an exiting surface of the light beam, the areas having grid grooves with different angles alternately formed thereon.

8. A diffraction grating for splitting a light beam into a plurality of beams, the grating having grid grooves with two different angles formed on an exiting surface of the light beam.

9. An optical pickup device including a splitting unit which is the diffraction grating according to any one of claim 4, the splitting unit being adapted to split a light beam emitted from the laser source into one main light beam and a plurality of sub-light beams.

10. An optical disk apparatus equipped with the optical pickup device according to claim 1, the apparatus being further equipped with an actuator driving circuit for controlling driving of an actuator of the objective lens using a signal output from the photodetector of the optical pickup device.

11. An optical pickup device comprising
a laser source;
a splitting unit for splitting a light beam emitted from the laser source into one main light beam and a plurality of sub-light beams;
an objective lens for focusing the main light beam and the sub-light beams on an optical disk; and
a photodetector for receiving reflected beams of the main light beam and the sub-light beams from the disk,
wherein at least two sub-light beams are focused on each of forward and backward sides in a rotational direction of the disk with respect to the main light beam focused on the disk, and
wherein the two sub-light beams focused on each of the forward and backward sides are spaced apart from each other by about 1.85 μm in the disk radial direction.

12. The optical pickup device according to claim 11, wherein the photodetector includes at least three detection areas for respectively receiving the reflected light beam of the main light beam from the optical disk, the reflected light beams of the two sub-light beams from the disk focused on the forward side in the rotational direction of the disk with respect to the main light beam, and the reflected light beams of the two sub-light beams from the disk focused on the backward side in the rotational direction of the disk with respect to the main light beam,
wherein each of the three detection areas has at least two receiving surfaces separated in a predetermined direction corresponding to the radial direction of the disk, and
wherein a signal is output to enable generation of a tracking error signal from a difference between signals individually detected at the two receiving surfaces by a push-pull system, in each detection area.
